(19) United States
(12) Patent Application Publication
(10) Pub. No.: US 2017/0013552 A1
(43) Pub. Date: Jan. 12, 2017

(54) METHOD AND APPARATUS FOR NETWORK ENERGY ASSESSMENT

(71) Applicant: ALCATEL LUCENT, Boulogne-Billancourt (FR)

(72) Inventors: Kerry HINTON, PARKVILLE VIC (AU); Chien Aun CHAN, PARKVILLE VIC (AU)

(73) Assignee: Alcatel Lucent, Boulogne-Billancourt (FR)

(21) Appl. No.: 15/119,461

(22) PCT Filed: Mar. 12, 2015
(86) PCT No.: PCT/US2015/020087

§ 371 Date: Aug. 17, 2016

Related U.S. Application Data
(60) Provisional application No. 61/951,833, filed on Mar. 12, 2014.

(51) Int. Cl. H04W 52/02; H04L 12/26

(52) U.S. Cl. CPC H04W 52/0203; H04L 43/0888

(57) ABSTRACT

A method and apparatus for energy assessment in a communication network. The network may consist of a number of different portions, such as network elements or sub-networks that may be evaluated separately. By methods described herein, the idle-power consumption and the incremental-power consumption may be determined and combined to form a total power consumption allocation. An equitable allocation may in this way be provided for each service that shares network resources, and in some cases for the network operator as well.

### CROSS-REFERENCE TO RELATED APPLICATIONS

The present disclosure is related to and claims priority from U.S. Provisional Patent Application Ser. No. 61/951,833, entitled Method and Apparatus for Network Energy Assessment and filed on 12 Mar. 2014, the entire contents of which are incorporated by reference herein.

### TECHNICAL FIELD

The present invention relates generally to the field of communication networks, and, more particularly, to a method and apparatus for an energy assessment of all or a portion of a network that includes an allocation of power consumption to one or more services using the network.

### BACKGROUND

Communication networks carry network data traffic from one device to another, or to several devices, via a number, and often a large number of intermediary devices according to established or emerging communication protocols. Such networks are becoming larger and widespread, and are used by a wide variety of service providers. Because communication networks are so widespread and widely used, the energy required for their operation has been the cause of some concern. In one aspect this concern focuses on reducing unnecessary power consumption, and in another quantifying the actual or anticipated consumption for public relations or regulatory purposes. Operators are interested in determining and reducing their carbon footprint. Naturally, they are interested in obtaining as accurate an energy assessment as possible. The services that use a network are, in turn, concerned that this assessment is fair, especially where a number of services use the same network, Service providers want to ensure that they are not being charged with some amount of power consumption that should properly be charged to someone else.

Energy assessment seems straightforward at first glance, but when undertaken presents a number of complications. One complicating factor, as mentioned above, is the fact that a number of services may share some or all of the resources of a given communication network. Equitably allocating power consumption (or anticipated power consumption) to each service or service provider may in reality be difficult, especially when changes made to one service may affect the allocation given to another. Described herein is a manner of making energy assessments that is intended to address these and other concerns.

Note that any techniques or schemes described herein as existing or possible are presented as background for the present invention, but no admission is made thereby that these techniques and schemes were heretofore commercialized or known to others besides the inventors.

### SUMMARY

The present disclosure teaches a manner of energy assessment for a communication network. In one aspect, an energy-assessment method for allocating power consumption in a communication network is taught, the method including calculating an allocation to at least one service for incremental-power consumption in at least one portion of the network, calculating an allocation to at least one service for idle-power consumption in at least one portion of the network, and calculating as a function of the incremental-power consumption and the idle-power consumption an allocation to the at least one service for total power consumption in the at least one network portion. In some embodiments, the at least one network portion comprises a plurality of network portions and wherein calculating an allocation for total power consumption comprises calculating the total power consumption for the plurality of network portions. The plurality of network portions may include all portions of the communication network used by the at least one service. An allocation to the network operator may be included in some preferred embodiments. A network portion may be, for example, a network element or a sub-network.

Embodiments may also include reporting the total power consumption for the at least one service, wherein the total power consumption for the at least one service comprises at least the sum of the calculated total power consumption values for each of the plurality of network portions. In a preferred embodiment, the power consumption values are stored in an allocation table or similar storage facility.

Embodiments may also include determining for at least one portion of the network a value for E, wherein E is the slope of a line representing the incremental increase of power consumption over idle-power consumption Pₘᵢₙ as throughput increases for the network portion. In some implementations, this may include determining that E=0. In others calculating E as a fraction of the total power consumption Pₘₐₓ of the network portion at maximum throughput Cₘₐₓ. In still others E is determined to be a default value. An E value may apply to all services using a given network potion, but in some embodiments a separate E value may be determined for one or more services. In some embodiments, calculating the incremental-power consumption for at least one service comprises calculating an allocation for incremental-power consumption according as a product of E and a value for the throughput contribution Cⱼ of the service through the network element.

In another aspect, the disclosure teaches an energy assessment apparatus including a processor for controlling the components of the apparatus and a memory for storing data and program instructions that when executed cause the apparatus to perform one or more of the energy assessment methods described herein. The apparatus may include a power consumption calculator for calculating power consumption allocations and an allocation table for storing the results. A network interface may also be present.

Additional aspects will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a graph illustrating the dependence of power consumption P of a given network element in relation to throughput C;

FIG. 2 is a simplified schematic diagram illustrating a communication network in which this manner of performing an energy assessment may be implemented;

FIG. 3 is a simplified schematic diagram illustrating another communication network in which this manner of performing an energy assessment may be implemented;

FIG. 4 is a flow chart illustrating a method of energy assessment according to an embodiment of the present invention; and

FIG. 5 is a simplified block diagram illustrating an energy assessment apparatus according to an embodiment of the present invention.

### DETAILED DESCRIPTION

The present disclosure is directed of assessing the energy used by services in a communication network or portions thereof, and is especially of use in assessing the individual energy-consumption of various services that share a network or portions of a network.

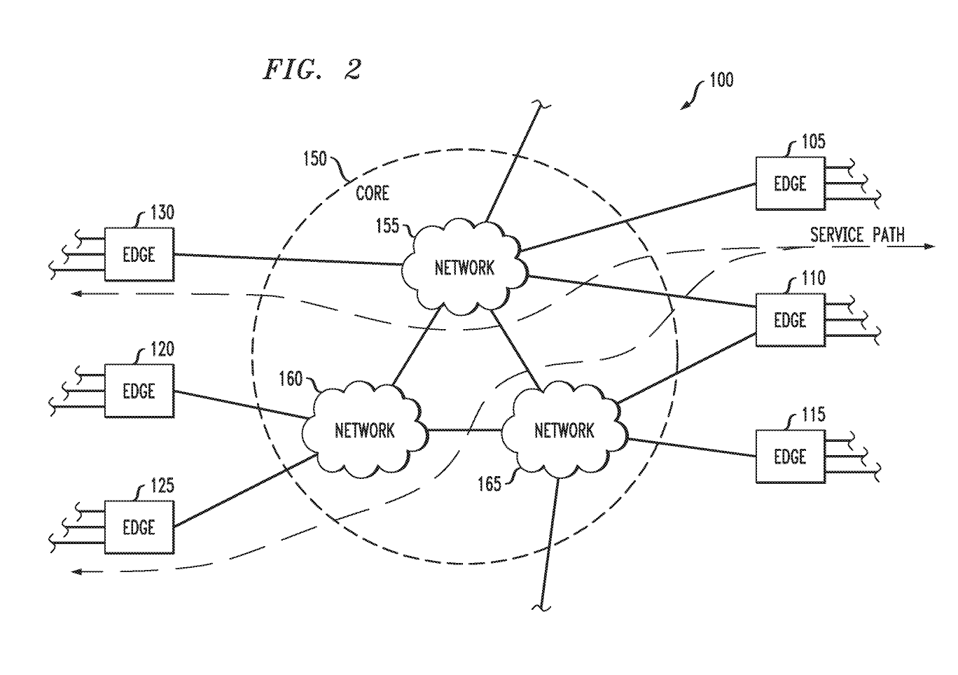

FIG. 2 is a simplified schematic diagram illustrating a communication network 100 in which this manner of performing an energy assessment may be implemented. Network 100 includes edge nodes 105, 110, 115, 120, 125, and 130. Edge nodes 105, 110, and 115 may be, for example, routers, switches, bridges, and so forth where customers or subscribers are connected to the network 100. Edge nodes 120, 125, and 130 may be, for example, equipment such as routers, switches, bridges, and so forth that act as gateways to other communication networks. Note that herein network nodes are sometimes also referred to as “elements”.

In this illustration, core 150 of network 100 includes network 155, network 160, and network 165, represented as clouds in FIG. 2. Each of networks 150, 155, and 160 in this illustration may include a number of individual interconnected nodes that are not here shown separately.

In a practical implementation, network 100 may be used, for example, to allow the subscribers connected to edge node 105, 110, and 115 to communicate with each other and with other devices (not shown) that are also in communication with network 100 or with the other networks to which one of the edge nodes 120, 125, and 130 provide access. Note that the configuration of network 100 of FIG. 2 is intended to be exemplary, and many other configurations are possible.

The energy-assessment method and apparatus described herein may be applied to network 100 or to portions of it, for example network 160. For convenience herein, however, the network or portion thereof under assessment will simply be referred to as the “network” unless more specific nomenclature is helpful in a particular embodiment. Each network is presumed to be formed by a number of individual elements such as edge nodes, switches, routers, and so forth.

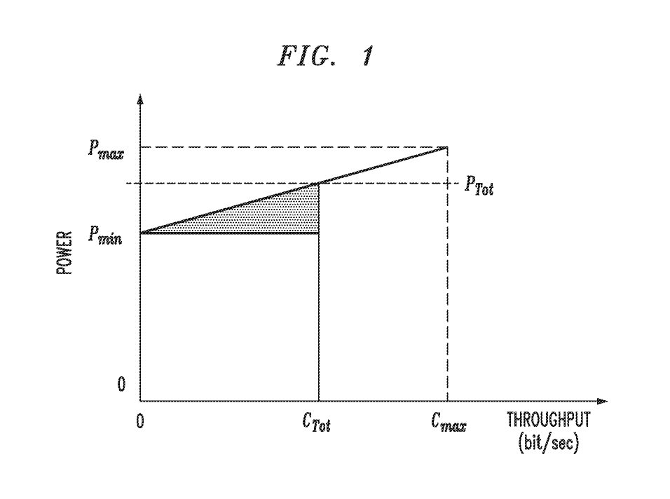

The power consumed by a network element may be graphically represented. FIG. 1 is a graph illustrating the dependence of power consumption P of a given network element in relation to throughput C. In FIG. 1, Pₘᵢₙ represents the power consumed by the network element in an idle state, that is, with no data traffic being processed through it, that is, when C=0. Pₘₐₓ then represents the power consumed by the network element in question when experiencing its maximum throughput Cₘₐₓ. Cₘₐₓ may be established by determining the equipment's practical limits, for example by reference to specifications or representations of the vendor.

In FIG. 2, P_{Tot} represents the power consumption of the network element, including both idle power and the additional power consumed when experiencing throughput C_{Tot}. Note that the power consumption profile of almost all network equipment, for example CPE (consumer premises equipment), mobile base stations, routers, switches, cross-connects, and so forth, can be accurately described by the shape in FIG. 2. This power profile consists of an idle power (Pₘᵢₙ) and an incremental linear increase in power consumed as the traffic throughput increases from zero to Cₘₐₓ.

The solution described herein may be used to allocate to the service or services using the network element (or other defined portion of the network) a share of the total power consumption and, from an aggregation of the network elements (or other network portions) a share of the power consumed or anticipated to be consumed by the network. Of course, if there is only one service propagating through the element or other network portion, allocation may amount to simply allocating the entire power consumption of that element to that service.

Note, however, that in some embodiments a portion of the power consumption allocation also may be made to the network operator (as described below). Note also that the power consumed may be actual or may be an anticipated value based, for example, on contractual parameters or limits established by the operator.

The present solution is of greatest advantage where multiple services share the resources of the network, including individual elements, and the allocation process becomes more difficult. This is frequently the case, for example, regarding services using metro or core networks. Note that each service may be but is not necessarily associated with a particular service provider.

A service may but does not necessarily use all portions of the network. In FIG. 2, for example, a service path is generally illustrated. Here, it connects edge node 110 with edge node 130 via network 155 and with edge node 125 via networks 160 and 165. Other service paths are of course possible in other implementations. It is preferable, however, to perform the energy assessment using the network portions actually used or anticipated to be used by the service.

A process of energy assessment according to embodiments of the present solution will now be described. In some embodiments, the total power consumption Pₜₒₜ of a given element is allocated to the services that use the element. If there are N services each with traffic propagating through the network element and the power consumption of the j-th service Pⱼ may be calculated by:

$${P}_{Tot} = {\sum }_{j = 1}^{N} {P}_{j} \qquad ( 1 )$$

Correspondingly, the total traffic throughput through the element may be expressed as the sum of the traffic throughput Cⱼ of each service (or service provider):

$${C}_{Tot} = {\sum }_{j = 1}^{N} {C}_{j} \qquad ( 2 )$$

In this embodiment, the incremental power consumption (above Pₘᵢₙ) attributable to a given service j contributing Cⱼ traffic to the total throughput experienced by the element may be expressed as:

P_{inc,j}=ECⱼ (3)

The calculation of E in equation (3) will be described below, but first a solution for allocation of a share of idle power Pₘᵢₙ to the network element is explained. Idle power Pₘᵢₙ is fixed and, as a consequence, the allocation of this power across multiple services will change depending upon the number of services sharing the element and the traffic of each service. For example, a simple allocation based on the proportion of traffic for each service would be:

$${P}_{min , j} = \frac{{C}_{j}}{{C}_{Tot}} \qquad ( 4 )$$

This allocation, although straight-forward and direct, has the disadvantage that when one service provider decides to change their traffic, this will change the power consumption of all other service providers using that element. As this fluctuation may be prejudicial to the service providers being evaluated, another method is preferred. The description of a preferred embodiment follows.

Generally speaking, all network equipment is normally operated at less than its maximum throughput, that is, C_{Tot}<Cₘₐₓ. This is because the network operator must ensure that if an sudden surge in traffic occurs, then no traffic (for example, data packets) are lost due to the traffic surge being greater than the element can handle (that is, larger than Cₘₐₓ). To ensure no traffic is lost, a network operator may operate its equipment below a pre-determined fraction of Cₘₐₓ. The total allowable traffic through an element may be given as UₘₐₓCₘₐₓ where Uₘₐₓ<1. The value of Uₘₐₓ is usually determined by a policy decision of the network operator. This means that for a network element:

$${C}_{Tot} = {\sum }_{j = 1}^{N} {C}_{j} < {U}_{max} {C}_{max} \qquad ( 5 )$$

In preferred embodiments of the assessment, some traffic is allocated to the network operator. In one embodiment, this allocation may be based on a total capacity C_{Tot} that is equal to UₘₐₓCₘₐₓ and given by:

$${C}_{Tot} = {U}_{max} {C}_{max} = {\sum }_{j = 1}^{N} {C}_{j} + {C}_{Operator} \qquad ( 6 )$$

where C_{Operator} is the traffic allocated to the network operator, and the throughput C_{Operator} through the element may be expressed as:

$${C}_{Operator} = {U}_{max} {C}_{max} - {\sum }_{j = 1}^{N} {C}_{j} \qquad ( 7 )$$

In this allocation, the network operator “picks up the difference” between the total service providers' traffic through the element and the maximum traffic that the element will be allowed to carry, and as a consequence each service provider's energy allocation of idle power is independent of any traffic changes due to other service providers.

In this embodiment, the idle-power consumption allocated to each service provider is:

$${P}_{min , j} = \frac{{P}_{min}}{{U}_{max} {C}_{max}} {C}_{j} \qquad ( 8 )$$

As mentioned above, this allocation will not change with changes in traffic load by other services or service providers.

In this embodiment, a portion of the idle-power consumption is also allocated to the network operator as follows:

$${P}_{min , Operator} = \frac{{P}_{min}}{{U}_{max} {C}_{max}} {C}_{Operator} = \frac{{P}_{min}}{{U}_{max} {C}_{max}} ( {U}_{max} {C}_{max} - {\sum }_{j = 1}^{N} {C}_{j} ) \qquad ( 9 )$$

In another embodiment, traffic-related power consumption is allocated to the network operator based on maximum throughput Cₘₐₓ. In this case, the idle-power allocation is based on a value of C_{Tot} that is equal to Cₘₐₓ and given by:

$${C}_{tot} = {C}_{max} = {\sum }_{j = 1}^{N} {C}_{j} + {C}_{Operator} \qquad ( 10 )$$

In this embodiment the network operator in effect picks up the difference between C_{Tot} and maximum capacity of the network element Cₘₐₓ. The idle-power consumption at the network element for each service is given by:

$${P}_{min , j} = \frac{{P}_{min}}{{C}_{max}} {C}_{j} \qquad ( 11 )$$

In this embodiment, the idle-power consumption allocated to the operator is determined by:

$${P}_{min , Operator} = \frac{{P}_{min}}{{C}_{max}} {C}_{OPerator} = \frac{{P}_{min}}{{C}_{max}} ( {C}_{max} - {\sum }_{j = 1}^{N} {C}_{j} ) \qquad ( 12 )$$

As should be apparent, both embodiments described above, the consumption of idle-power is completely allocated to some responsible party. Note that in either case some of the allocation is to the network operator. This allocation will change depending on the total traffic (ΣⱼCⱼ) through the element. In situations where reductions in power consumption are incentivized, the network operator is included. Finally, it is noted that the choice between the two alternatives will vary from one implementation to another and neither is presently preferred, although the latter avoids the need to determine Uₘₐₓ.

With this exception, the parameters that must in the usual case be measured or otherwise ascertained are:

Pₘₐₓ: This can be determined from the network element configuration. This data is easily available to the network operator either by measurement or provided by the equipment vendor.
Pₘᵢₙ: This is the idle power of the network element. Again, this data is easily available to the network operator either by measurement or provided by the equipment vendor.
Cₘₐₓ: This can be determined from the network element configuration. This data is easily available to the network operator from the equipment vendor.
Uₘₐₓ: Where used, this may be set by the policy decision and network design rules adopted by the network operator. Uₘₐₓ may be set to a default value in apparatus for performing the power allocation. A single Uₘₐₓ value may be used or a value set for each network element or type of element.
Cⱼ for the service under consideration: This may be provided by the service provider's specifications of traffic requirements. For example, the service provider may have a connection of X bits/second for the given service. In this case, the traffic allocation can be presumed to be X bits/second. Cⱼ may in other cases be determined by measurement, for example, the traffic emanating from the service provider's Point of Interconnect may be monitored to provide traffic logs. This data can then be used to provide the values of Cⱼ over the duration of the service.
E for the network element: This is the slope of the line depicted in FIG. 1. Note that in some implementations, E may be dependent on the type as well as the quantity of traffic. In this case, Eⱼ may be (but is not necessarily) determined for each service. Where this is done, Eⱼ may be used in place of E in determinations applicable to service j.

The determination of E typically depends on the type of network element. Many network elements have E=0 or E≈0. In these cases the power consumption of a service is effectively determined by the allocation of the idle power consumption to that service as discussed above because the allocation of incremental-power consumption may be considered zero as well.

In other cases E≠0. In this case E may be determined using, for example, a direct measurement of the power consumption and traffic load of the network element. This typically requires attaching a power meter to the element to record the power consumption and accessing the traffic logs for the element. If it is not practical to use direct measurement, then E can be approximated from knowledge of the equipment type. Most modern routers and switches have Pₘᵢₙ≈0.8 to 0.9 Pₘₐₓ. Knowing the approximate proportion gives E≈0.1 to 0.2 Pₘₐₓ/Cₘₐₓ. In some embodiments the determination of E may involve such an approximation or, alternately, the acceptance of a default value, for example E_{default}=0.15 Pₘₐₓ/Cₘₐₓ.

In implementations where E is strongly traffic dependent, that is, it may vary according to the type of traffic passing through an element, it may be desirable to calculate an E for use in allocating power consumption to the j-th service. This may also be applied in implementations where the idle power of the equipment is significantly reduced to the extent that the incremental power dominates the total power consumption calculation even under typical operational conditions.

For example, from experiments undertaken, the total power consumption of a network element may in some cases may be written in the form:

$${P}_{tot} = {P}_{min} + {\sum }_{j = 1}^{N} ( {E}_{proc} + {E}_{S \& F} {N}_{pkt , j} ) {C}_{pkt , j} = {P}_{min} + {\sum }_{j = 1}^{N} {E}_{j} {C}_{pkt , j} \qquad ( 13 )$$

This form recognizes the fact that different services generate different types of traffic. For example, the packet size (N_{Pkt,j}) and packet rate (C_{Pkt,j}) will be different for services such as: download-and-store video service, real-time viewing video service, VOIP, email, and so forth.

In this equation (13) for P_{Tot}, the parameter Eⱼ is in units of energy per packet and C_{Pkt,j} is in units of packets per second. Eⱼ is the total energy per packet that the network element consumes for each packet it deals with for the j-th service. C_{Pkt,j} is the packet rate for that service. The value of C_{Pkt,j} corresponds to the value of Cⱼ introduced above and is similarly determined.

In one embodiment, then, Eⱼ is given by

Eⱼ=E_{proc}+E_{S&F}N_{pkt,j} (14)

In this embodiment, the value of N_{Pkt,j} can be determined by multiple means, including: a) Measurement, b) knowledge of the packet length for the given service, and c) using the network element traffic logs. Each of these will is relatively simple and will provide the information required to determine N_{Pkt,j}.

Evaluating the terms E_{Proc} and E_{S&F} requires measurement on the network element. In some cases this requires the network element to be taken “off-line” to perform the measurements. In the alternative, equipment may be measured to determine E_{Proc} and E_{S&F} as part of the manufacturing process. In this case the values would be published by the equipment vendor. Since undertaking the measurements required in this situation is non-trivial, this embodiment is not presently preferred. Of course, the value of E in these situations may be instead determined as described above in relation to other embodiments.

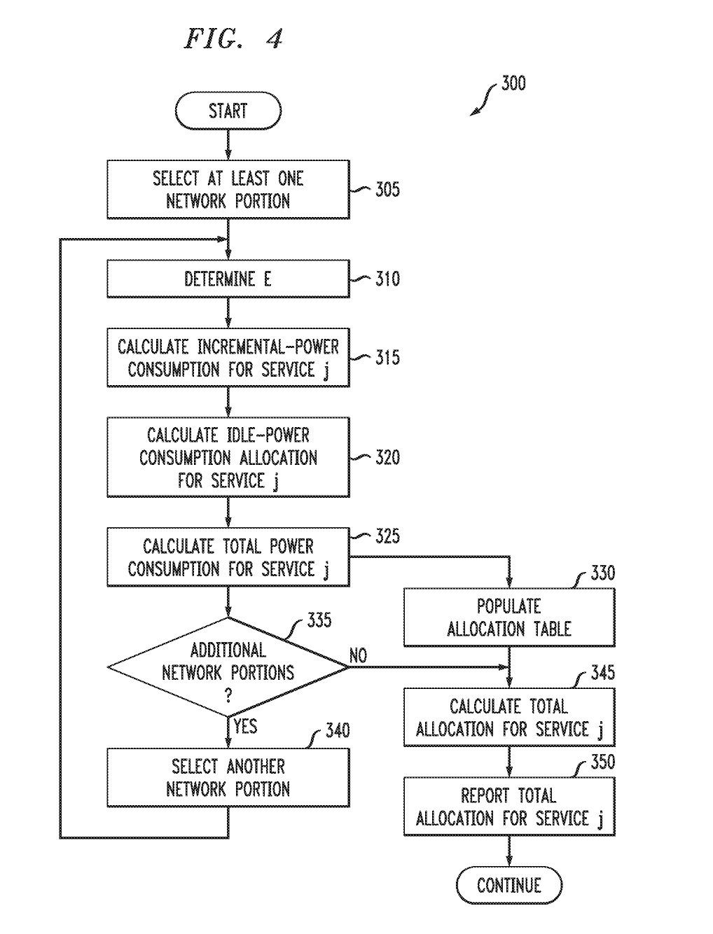

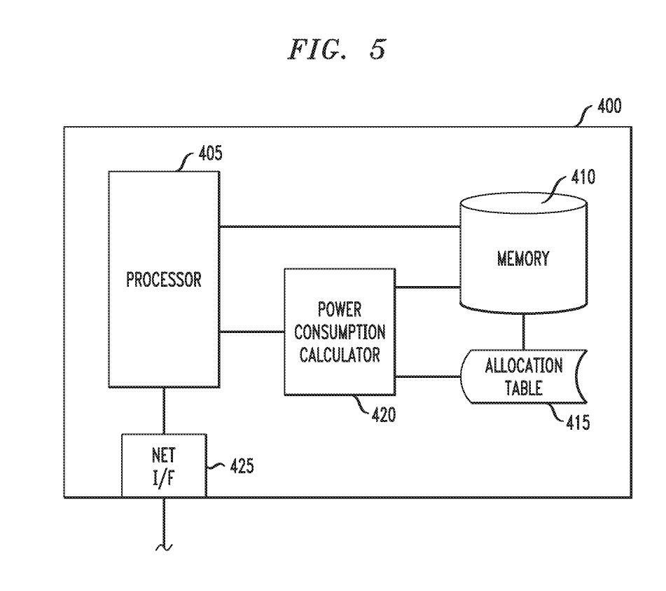

FIG. 4 is a flow chart illustrating a method 300 of energy assessment according to an embodiment of the present invention. At START it is presumed that the necessary components are available and operable at least according to this embodiment (see, for example, FIG. 5). The process then begins with selection of at least one portion of the network (step 305). This network portion may be, for example, a network element or in some cases a collection of network elements or a sub-network.

In the embodiment of FIG. 4, for this network portion a value of E is then determined (step 310), for example according to one of the methods described herein. Note that since E is used in incremental-power allocations, if such allocations are not considered necessary, E may simply be set to zero. In some embodiments, this step may simply be omitted. And as mentioned above, where applicable a separate Eⱼ for each service may be determined if desired.

In this embodiment, the incremental-power consumption allocation associated with the selected network portion is then calculated (step 315), as is the portion of idle power for the network portion that is to be allocated to the service (step 320). These calculations may be performed, for example, according to the various methods described herein. If for some reason either incremental or idle power need not be included, of course, the corresponding step may be omitted. And if a network portion is used exclusively by one service or service provider, that service may be allocated some or all of the incremental- or idle-power consumption, or both (with or without considering an operator's apportionment).

In the embodiment of FIG. 4, the total power consumption allocation of service j for the network portion may then be calculated. In this embodiment, the calculation includes the incremental power and the idle power allocated to service j for this network portion. In light of the description provided above the allocation of power consumption by the service j may be expressed as one of the following, depending on whether a Uₘₐₓ is being considered:

$$\begin{matrix}{P}_{j} = {EC}_{j} + \frac{{P}_{min}}{{U}_{max} {C}_{max}} {C}_{j} & ( 15 ) \\ {P}_{j} = {EC}_{j} + \frac{{P}_{min}}{{C}_{max}} {C}_{j} & ( 16 )\end{matrix}$$

In the embodiment of FIG. 4, an allocation table (for example, allocation table 415 shown in FIG. 5) may be populated (step 330) at this time in order to track the allocations. A determination (step 335) is then made as to whether all of the desired network portions have been analyzed. In a preferred embodiment, the desired network portions are determined by the network operator as some network portion may not need to be included. In the embodiment of FIG. 4 if a determination is made at step 335 that additional network portions should be examined, the process returns to step 310 and determines the power allocation for another network portion.

In this embodiment, if, on the other hand, the determination at step 335 is that no additional network portions need be examined, the process proceeds to calculate (step 345) the total power allocation for service j based on the allocations made for each network portion. Note that if network portions that are used exclusively by service j (not shared with other services), their contribution to total power consumption allocation should also be included in the calculation of step 345 (not shown in FIG. 4). Note that although not shown in FIG. 4, the power allocation for the network operator may also be calculated at this time (as described elsewhere herein) and recorded in the allocation table.

The results of the allocation may then be reported (step 350) to the network operator or others. The process then continues, if necessary, for example for power consumption allocation to a different service or service provider.

Note that the sequence of operations illustrated in FIG. 4 represents an exemplary embodiment; some variation is possible. For example, additional operations may be added to those shown in FIG. 4, and in some implementations one or more of the illustrated operations. In addition, the operation of the method may be transmitted and received in any logically-consistent order unless a definite sequence is recited in a particular embodiment.

Certain of the embodiments described above may be described as a “bottom-up” approach as they involve the calculation of power-consumption of network equipment that is the aggregated for determining the power consumption of the network. In alternate embodiments, a “top-down” approach may be used instead of (or in some cases in addition to) the bottom-up approach. These alternate embodiments provides for a network energy assessment that requires less data collection though in some cases a less accurate assessment may have to be tolerated. The top-down approach according to various embodiments will now be described.

Because the power profile of all network equipment is well approximated by FIG. 1, the dependence on traffic of the power consumption of an entire network will have the same form. The total network power profile will consist of an idle power Pₘᵢₙ, an incremental E, and a maximum throughput Cₘₐₓ. Most network equipment has Pₘᵢₙ≈0.9 Pₘₐₓ hence the network is expected to also satisfy this approximation.

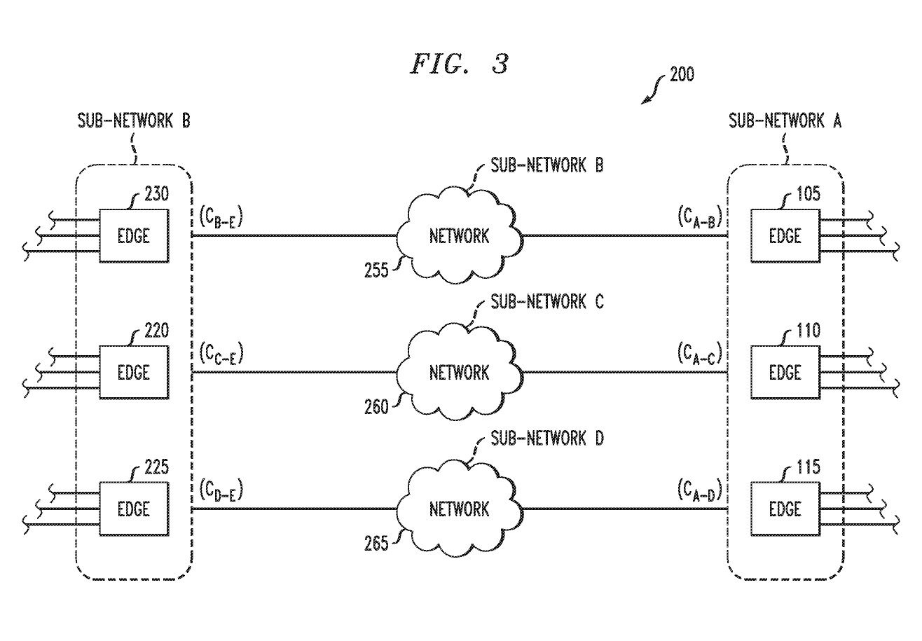

Consider the network 200 that carries as depicted in FIG. 3. FIG. 3 is a simplified schematic diagram illustrating a communication network 200 in which this manner of performing an energy assessment may be implemented. Note that network 200 is similar though not necessarily identical to network 100 shown in FIG. 2.

In the embodiment of FIG. 3, networks 255, 260, and 265 have been respectively designated sub-networks B, C, and D for purposes of the assessment. These sub-networks carry traffic between sub-network A, which includes edge devices 105, 110, and 115, and sub-network B, which here includes edge devices 220, 225, and 230 over a number of labeled interfaces. Note that as implied in FIG. 3, each edge device may communicate over a plurality these interfaces with a respective network. Of course, the number of devices and the interface configuration shown here is exemplary and may vary by specific implementation.

If the path or paths of the service data traffic through the network are known, then the details of each network element along the path may be extracted and the energy-assessment may be performed using the bottom-up approach. This is frequently not the case, however, hence the top-down alternative. In such alternate embodiments, if the service paths are not ascertainable then it is presumed that the distribution of the service traffic is approximately even. In that case, the network power consumption can be based on average or cumulative values of Pₘᵢₙ, Pₘₐₓ, E and Cₘₐₓ for each of the three core sub-networks.

Referring to FIG. 3, in this embodiment it is presumed that the traffic into sub-network A is known, for example by the contracted provision by the network operator of bandwidth C_{A,j} to a specific service provider j. The power consumption due to service Cⱼ in sub-network A is

$${P}_{A , j} = {E}_{A} {C}_{j} + \frac{{P}_{A , min}}{{U}_{A , max} {C}_{A , max}} {C}_{j} \qquad ( 17 )$$

where, for sub-network A, P_{A, min} is the total idle power consumption, C_{A, max} is the total maximum throughput capacity deployed, U_{A, max} is the maximum utilization and E_{A}=(P_{A,max}−P_{A,min})/C_{A,max}, with P_{A, max} being the power consumption for C_{A, max}.

In this embodiment, since (Σⱼ₌₁^{N}Cⱼ)<(UₘₐₓCₘₐₓ), the network operator A may be allocated power consumption of equation (18):

$${P}_{min , Operator A} = \frac{{P}_{A , min}}{{U}_{A , max} {C}_{A , max}} {C}_{OPerator A} = \frac{{P}_{A , min}}{{U}_{A , max} {C}_{A , max}} ( {U}_{A , max} {C}_{A , max} - {\sum }_{j = 1}^{N} {C}_{A , j} )$$

In the embodiment of FIG. 4, the service traffic Cⱼ is spread over the three sub-networks B, C, and D before passing to sub-network E. In this case the total traffic output by edge network E is equal to the sub-network A input traffic Cⱼ. Furthermore, the idle power consumption allocated to network operators B, C, D, and E can be determined using equation (17) by replacing operator A's parameters by parameters of operators B, C, D, and E.

If the proportions of service Cⱼ through each of the sub-networks B, C, and D are known, then the total power consumption of the service for each sub-network may be calculated using those proportions:

$${P}_{B , j} = {E}_{B} {∝}_{B} {C}_{j} + \frac{{P}_{B , min}}{{U}_{B , max} {C}_{B , max}} {∝}_{B} {C}_{j} \\ {P}_{C , j} = {E}_{C} {∝}_{C} {C}_{j} + \frac{{P}_{C , min}}{{U}_{C , max} {C}_{C , max}} {∝}_{C} {C}_{j} \\ {P}_{D , j} = {E}_{D} {∝}_{D} {C}_{j} + \frac{{P}_{D , min}}{{U}_{D , max} {C}_{D , max}} {∝}_{D} {C}_{j} \qquad ( 19 )$$

where ∞_{B}+∞_{C}+∞_{D}=1 are the proportions of the traffic Cⱼ through the respective sub-networks.

If these proportions are not known, in this the service traffic C, allocation to the sub-networks B, C, and D may be approximated based on either the interconnection capacities between the networks: C_{A-B}, C_{A-C}, C_{A-D} or their individual maximum capacities (C_{B, max}, C_{C, max}, C_{D, max}). The choice between these alternatives may vary from one implementation to another and may be based, for example, on the data available and the reasonableness of the approximations.

In an embodiment using interconnection capacities in a top-down approach, the power allocation for each sub-network may be calculated by:

$$\begin{matrix}{P}_{B , j} = {E}_{B} {β}_{B} {C}_{j} + \frac{{P}_{B , min}}{{U}_{B , max} {C}_{B , max}} {β}_{B} {C}_{j} \\ {P}_{C , j} = {E}_{C} {β}_{C} {C}_{j} + \frac{{P}_{C , min}}{{U}_{C , max} {C}_{C , max}} {β}_{C} {C}_{j} \\ {P}_{D , j} = {E}_{D} {β}_{D} {C}_{j} + \frac{{P}_{D , min}}{{U}_{D , max} {C}_{D , max}} {β}_{D} {C}_{j} \\ where & ( 20 ) \\ {β}_{B} = \frac{{C}_{A - B}}{{C}_{A - B} + {C}_{A - C} + {C}_{A - D}} \\ {β}_{C} = \frac{{C}_{A - C}}{{C}_{A - B} + {C}_{A - C} + {C}_{A - D}} \\ {β}_{D} = \frac{{C}_{A - D}}{{C}_{A - B} + {C}_{A - C} + {C}_{A - D}} & ( 21 )\end{matrix}$$

In an embodiment using maximum capacities in a top-down approach, the power allocation for each sub-network may be calculated by:

$$\begin{matrix}{P}_{B , j} = {E}_{B} {β}_{B} {C}_{j} + \frac{{P}_{B , min}}{{U}_{B , max} {C}_{B , max}} {β}_{B} {C}_{j} \\ {P}_{C , j} = {E}_{C} {β}_{C} {C}_{j} + \frac{{P}_{C , min}}{{U}_{C , max} {C}_{C , max}} {β}_{C} {C}_{j} \\ {P}_{D , j} = {E}_{D} {β}_{D} {C}_{j} + \frac{{P}_{D , min}}{{U}_{D , max} {C}_{D , max}} {β}_{D} {C}_{j} \\ where & ( 22 ) \\ {β}_{B} = \frac{{C}_{B}}{{C}_{B} + {C}_{B} + {C}_{B}} \\ {β}_{C} = \frac{{C}_{C}}{{C}_{C} + {C}_{C} + {C}_{C}} \\ {β}_{D} = \frac{{C}_{D}}{{C}_{D} + {C}_{D} + {C}_{D}} & ( 23 )\end{matrix}$$

In the top-down embodiment calculation for the subnet-work division of FIG. 4 regardless of whether interconnection capacities or maximum capacities are used, the power consumption allocated to sub-network E is then:

$${P}_{E , j} = {E}_{E} {C}_{j} + \frac{{P}_{E , min}}{{U}_{E , min} {C}_{E , max}} {C}_{j} \qquad ( 24 )$$

and the total power consumption allocated to service j is given by:

Pⱼ=P_{A,j}+P_{B,j}+P_{C,j}+P_{D,j}+P_{E,j} (25)

Note that the top-down approach does require that power and capacity values for the networks or sub-networks used by service j are available or subject to calculation. It nevertheless requires less input data than the bottom up approach, albeit at an expected loss in accuracy. Using either of the top-down or bottom-up approach, or a combination of both, an energy assessment may be made to allocate to the various services using a network a power consumption value.

Note also that the sequences of operation described represent exemplary embodiments; some variation is possible within the spirit of the invention. Note also that in a practical implementation, attention should be focused on the most energy-intensive equipment, in most network switches and routers for example. For ease in data collection and calculation, equipment that normally consumes relatively less power, for example some cross-connects or multiplexors, can often be ignored without a large impact in accuracy.

FIG. 5 is a simplified block diagram illustrating an energy assessment apparatus 400 according to an embodiment of the present invention. In this embodiment, apparatus 400 includes a processor 405 and a memory device 410. Memory device 410 in this embodiment is a physical storage device that may in some cases operate according to stored program instructions. In any case, in this embodiment memory 410 is non-transitory in the sense of not being merely a propagating signal (although this may not be true in other embodiments, not shown). Memory 410 is used for storing, among other things, data as well as stored program instructions for execution by processor 405.

Shown separately in FIG. 4 is an allocation table 415 for storing, for example, an identification of the portions of communication networks 100 or 200 (shown in FIGS. 2 and 3) and the services to be evaluated, as well as the actual power consumption allocations made according to this disclosure by power consumption calculator 420. A network interface 425 is present for communicating, for example, with the communication networks 100 or 200, or both, or with other networks or devices for the purpose of receiving data and instructions and reporting results.

In this embodiment, processor 405, power consumption calculator 420, and network interface 425 are implemented in hardware or hardware implementing stored program instructions, or both.

FIG. 5 illustrates selected components of an embodiment and some variations are described above. Other variations are possible without departing from the claims of the invention as there recited. In some of these embodiments, illustrated components may be integrated with each other or divided into subcomponents. There will often be additional components in the device management server and in some cases less. The illustrations components may also perform other functions in addition to those described above.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An energy-assessment method for allocating power consumption in a communication network, comprising:
calculating an allocation to at least one service for incremental-power consumption in at least one portion of the network;
calculating an allocation to at least one service for idle-power consumption in at least one portion of the network; and
calculating as a function of the incremental-power consumption and the idle-power consumption an allocation to the at least one service for total power consumption in the at least one network portion.

2. The energy-assessment method of claim 1, wherein the at least one network portion comprises a plurality of network portions and wherein calculating an allocation for total power consumption comprises calculating the total power consumption for the plurality of network portions.

3. The energy-assessment method of claim 2, wherein the plurality of network portions comprises all portions of the communication network used by the at least one service.

4. The energy-assessment method of claim 2, further comprising reporting the total power consumption for the at least one service, wherein the total power consumption for the at least one service comprises at least the sum of the calculated total power consumption values for each of the plurality of network portions.

5. The energy-assessment method of claim 1, further comprising determining for at least one portion of the network a value for E, wherein E is the slope of a line representing the incremental increase of power consumption over idle-power consumption Pₘᵢₙ as throughput increases for the network portion.

6. The energy-assessment method of claim 5, wherein determining for at least one portion of the network a value for E, comprises determining that E=0.

7. The energy-assessment method of claim 5, wherein determining for at least one portion of the network a value for E comprises calculating E as a fraction of the total power consumption Pₘₐₓ of the network portion at maximum throughput Cₘₐₓ.

8. The energy-assessment method of claim 1, wherein calculating an allocation for incremental-power consumption for at least one service comprises calculating an allocation for incremental-power consumption according as a product of E and a value for the throughput contribution Cⱼ of the service through the network element.

9. The energy-assessment method of claim 1, wherein the at least one network portion is a network element.

10. The energy-assessment method of claim 1, wherein the at least one network portion is a sub-network.
